(19) United States
(12) Patent Application Publication
(10) Pub. No.: US 2012/0035944 A1
(43) Pub. Date: Feb. 9, 2012

(54) Medical Second Opinion System

(76) Inventor: David Phillip Gobel, Springfield, VA (US)

(21) Appl. No.: 12/852,503

(22) Filed: Aug. 8, 2010

(51) Int. Cl. G06Q 50/00; G06Q 10/00

(52) U.S. Cl. 705/2

(57) ABSTRACT

An electronic medical second opinion system. Medical professionals of various specialties are electronically connected to provide opinions on a specific medical problem. A member may post a request for second opinions in a standard form, and other members may respond by submitting their suggestions in standard form. The submitted suggestions are analyzed statically and are summarized into a final second opinion based on the statistical analysis.

### BACKGROUND OF THE INVENTION

1. Field of the Invention

The present application relates to an opinion valuing system, and more particularly to an electronic medical opinion valuing system that systematically connects medical professionals and seeks out a collective second opinion to a particular medical problem.

2. Background of the Invention

To provide an accurate medical diagnosis and then prescribe treatments for a particular disease, medical practitioners need to use a combination of science, observations of specific patients and application of physician experience. However, one person's knowledge and experience is limited. Communication with other expertise is needed to develop a sufficiently complete view on the subject in order to form an opinion. Second opinions often need to be consulted.

An effective methodology for discovery has been proven to be the financial market for “price discovery” where one can determine the price of an object or service in real time across vast times and distances through the collective wisdom of crowds.

Another example of wisdom of crowds is the recent “who wants to be a millionaire” TV show wherein contestants had several means/methods of getting help while answering questions. The most effective of these methods was to “ask the audience.” The contestant asks the studio audience which answer they believe is correct. Members of the studio audience indicate their choices using an audience response system. This is a popular lifeline, known for its near-perfect accuracy. It was said that the audience's answer is statistically 95% of the time correct.

An electronic medical communication system that takes advantage of the state of the art diagnostics available, that connects physicians in a un-intruding way would facilitate medical practitioners the ability to diagnose or detect multifactorial medical problems which could also take crucially into account *all* of the fields of medicine that can impact directly or significantly marginally upon a medical issue, and to access to the world's best minds on a topic in particular fields of medical endeavor.

### SUMMARY OF THE INVENTION

The present application discloses new approaches to generating valued medical second opinions.

An electronic network of medical professionals are created. Usernames indicating subjects of medical expertise are given, and communications are otherwise remained anonymous.

In one embodiment, a member may electronically submit and post a request for second opinions using a standardized form wherein symptoms of a disease or a patient are listed from the most severe to less severe. Images may also be attached to the request form. The request is then posted on a posting board for specified amount of time, and members of the network can submit and post their comments and suggestions.

In another aspect of an embodiment, the suggestions or comments of a member is electronically submitted using a standardized form, wherein each solution step is listed from the most important to less important.

The responding suggestions from plurality of members are collected and steps of the solutions are compared. Each step is marked with certain number of points with the more important steps having more points. Points of similarly suggested step from individual members are added, steps which have higher collective points from all suggestions are ranked higher on the final solution list. A final second opinion is then formed by listing all steps in accordance with their ranking points from the participating members.

In one embodiment, certain weight ratio may be given to the suggestions of the members who have more experience in the particular area.

In another aspect of an embodiment, members participate using their usernames and a score may be accumulated to indicate their performance. Their scores reflect a sum of the points of their suggested steps in the final second opinion.

The disclosed innovations, in various embodiments, provide one or more of at least the following advantages. However, not all of these advantages result from every one of the innovations disclosed, and this list of advantages does not limit the various claimed inventions.
Better medical care and health and survival outcomes;
Lower medical costs and higher profits for the medical community;
Lower legal and litigation costs;
Faster propagation of successful medical practice;
Lower malpractice insurance costs;
Allow superb diagnosticians to deliver and focus these skills to the community without distraction;
Deliver vastly diversified on-point medical knowledge to every given case.

The more important features of the invention have thus been outlined in order that the more detailed description that follows may be better understood and in order that the present contribution to the art may better be appreciated. Additional features of the invention will be described hereinafter and will form the subject matter of the claims that follow.

Before explaining at least one embodiment of the invention in detail, it is to be understood that the invention is not limited in its application to the details of construction and the arrangements of the components set forth in the following description or illustrated in the drawings. The invention is capable of other embodiments and of being practiced and carried out in various ways. Also it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

The foregoing has outlined, rather broadly, the preferred feature of the present invention so that those skilled in the art may better understand the detailed description of the invention that follows. Additional features of the invention will be described hereinafter that form the subject of the claims of the invention. Those skilled in the art should appreciate that they can readily use the disclosed conception and specific embodiment as a basis for designing or modifying other structures for carrying out the same purposes of the present invention and that such other structures do not depart from the spirit and scope of the invention in its broadest form.

### BRIEF DESCRIPTION OF THE DRAWINGS

Other aspects, features, and advantages of the present invention will become more fully apparent from the following detailed description, the appended claim, and the accompanying drawings in which similar elements are given similar reference numerals.

FIG. 1 schematically shows example components of an electronic medical second opinion system in accordance with this application.

FIG. 2 schematically demonstrates an example of formatted request of second opinions and an example of formatted suggestion in accordance with this application.

FIG. 3 schematically demonstrates an example of the collective final suggestion in accordance with this application.

FIG. 4 demonstrates an example of accumulation of award points of participating medical members.

### DETAILED DESCRIPTION OF SAMPLE EMBODIMENTS

The numerous innovative teachings of the present application will be described with particular reference to presently preferred embodiments (by way of example, and not of limitation). The present application describes several inventions, and none of the statements below should be taken as limiting the claims generally.

For simplicity and clarity of illustration, the drawing figures illustrate the general manner of construction, and description and details of well-known features and techniques may be omitted to avoid unnecessarily obscuring the invention. Additionally, elements in the drawing figures are not necessarily drawn to scale, some areas or elements may be expanded to help improve understanding of embodiments of the invention.

The terms “first,” “second,” “third,” “fourth,” and the like in the description and the claims, if any, may be used for distinguishing between similar elements and not necessarily for describing a particular sequential or chronological order. It is to be understood that the terms so used are interchangeable. Furthermore, the terms “comprise,” “include,” “have,” and any variations thereof, are intended to cover non-exclusive inclusions, such that a process, method, article, apparatus, or composition that comprises a list of elements is not necessarily limited to those elements, but may include other elements not expressly listed or inherent to such process, method, article, apparatus, or composition.

It is contemplated and intended that the design apply to any types of electronic networks of medical professionals, such as G3 wireless telecommunication system or other suitable system; for clarity reason, the examples are given based on the internet and web based server system, but an ordinary person in the art would know the variation and modification.

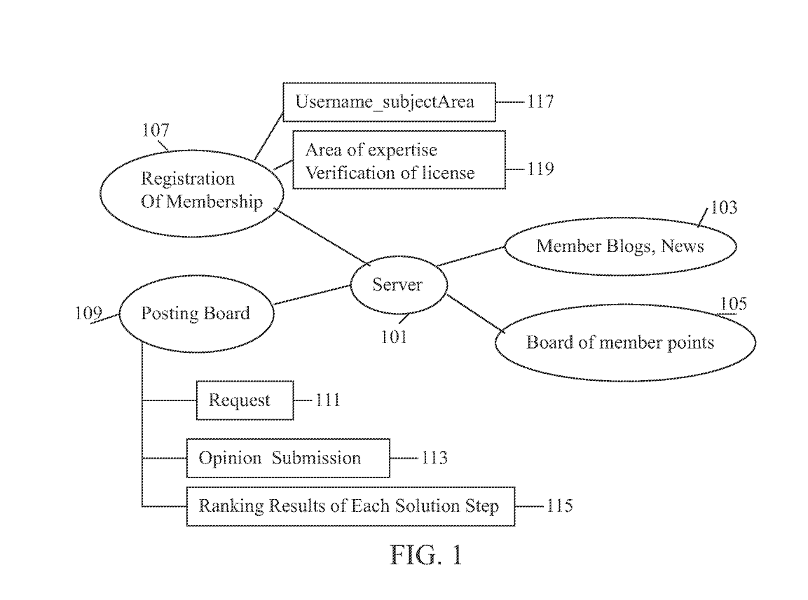

In reference to FIG. 1, an electronic network of medical professionals are created. This system comprises a server 101 that stores databases and executes controlling commands to correlate various functional modules. Electronically connected with the central server 101 includes a membership registration module 107 that creates a username to a registered medical member and also renders a medical license checkup function. Memberships are only activated with the verification of the members' medical licenses 119, which could be done by automatically searching various states' medical license databases or by a customer service personnel. Preferably a given username 117 has an appendix to indicate the member's area of expertise while the member remains largely anonymous. Thus, the provider, the identity of the answers/second opinions are totally anonymous so that there is no gaming/politics/intellectual free ride by any participant. Each participant can say what he/she alone believes is the correct diagnosis without intellectual distortion or influence from other participants.

Electronically connected with the central server 101 also include a request posting board 109, a posting board of member scoring 105 and member blogging and news service module 103.

Request posting board 109 preferably includes three functional components: request component 111 for posting request for second opinions in standard form; opinion submission component 113 for any participating member to submit his/her suggestions in standard form; and a final second opinion 115 to summarize the statistical results of the submitted suggestions.

Membership may be fee based on weekly, monthly and annually basis.

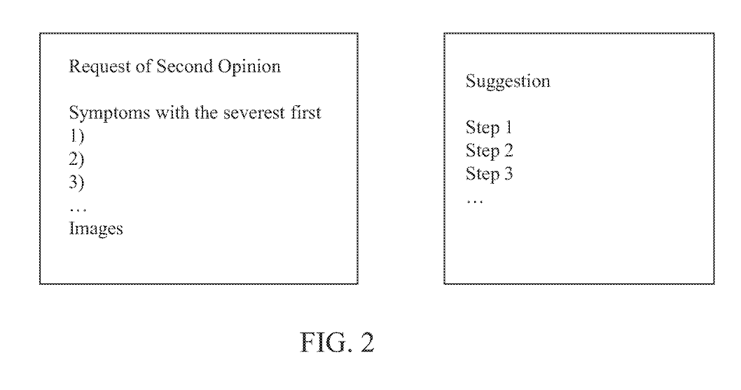

In reference to FIG. 2, the standard form of request for second opinions should list each obvious symptoms in a hierarchical order, either from the most severe to less severe or from the most obvious to less obvious symptoms. The Request for second opinions is then submitted to the server and stored in the database, and is simultaneously posted on the posting board 109 where all members of the network have free access to. The standard suggestion form should list simple steps of solutions in a hierarchical order, from the most urgent step to less urgent step, etc. The most important step is assigned with the highest points.

Thus, each individual who provides a second opinion receives an ongoing quality score that is based on whether or not their diagnoses turned out to be accurate. This requires that the doctor or person originating the diagnostic request must feed back the eventual correct diagnosis to the system so its participants can be scored, and the overall system then will give higher weight to the successful diagnosticians along with higher compensation/incentives, while lowering the score for the lesser successful/unsuccessful diagnosticians. Over time this will drive poor diagnosticians from the system because of low or no compensation, and gradually the system will ignore them while higher quality diagnosticians will have their answers given higher scores/weight, and they will be rewarded with larger monetary or other incentive consideration.

The standardize FICO like score that results over time will be available to participants so they can say in their off line marketing that they are in the 98% percentile of the best diagnostician as evidenced from the second opinion net system.

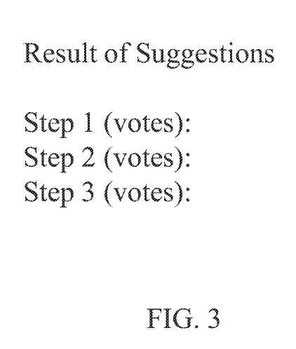

In reference to FIG. 3, the submission of suggestions from each participating member are collected and stored in the server 101, steps of each submission are compared with those of other submissions. Similar steps are grouped together and points may be summed. For the statistically generated final suggested solution step hierarchical order, the step that has the highest accumulative points may be placed as the first step in the hierarchy. A higher weight ratio may be given to members who have more experience or who are specialized in the area.

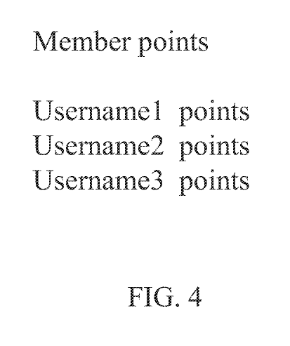

In reference to FIG. 4, each member's performance is recorded in a scoring system, preferably, the members who suggested a matching high point step gain that high points, the total score would be the sum points of his/her matching steps. Member performances are then posted on the board 105.

For membership benefits, the system may also provide and maintain member blogging services or medical community news with functional component 103.

The invention disclosed is applicable and useful to all forms of diagnosis and other problems which require the wisdom of a crowd. It is also very useful as a diagnostic simulator where medical personnel and members/students of other disciplines are participants in the system to offer their diagnoses which is objectively scored by the system for grading and certifications.

The system allows/facilitates automatic connections to and perhaps even remote control of remote diagnostic equipment.

Actual medical outcomes can be automatically supplied to the second opinion net. The system would be automatically informed of the primary physician's diagnosis by HIPPA compliantly mining standardized electronic medical records database, such as the Veterans Administration case history database, for the ongoing case history, standardized diagnostic and treatment codes, medicare codes, and outcome codes so they can provide automated/automatic feedback to the second opinion system as well as performance information such as savings achieved, lives saved, sufferings averted, reduced hospital stays, etc., which results from the second opinion system.

As will be recognized by those skilled in the art, the innovative concepts described in the present application can be modified and varied over a tremendous range of applications, and accordingly the scope of patented subject matter is not limited by any of the specific exemplary teachings given. It is intended to embrace all such alternatives, modifications and variations that fall within the spirit and broad scope of the appended claims.

None of the description in the present application should be read as implying that any particular element, step, or function is an essential element which must be included in the claim scope: THE SCOPE OF PATENTED SUBJECT MATTER IS DEFINED ONLY BY THE ALLOWED CLAIMS. Moreover, none of these claims are intended to invoke paragraph six of 35 USC section 112 unless the exact words “means for” are followed by a participle.

The claims as filed are intended to be as comprehensive as possible, and NO subject matter is intentionally relinquished, dedicated, or abandoned.

While there have been shown and described and pointed out the fundamental novel features of the invention as applied to the preferred embodiments, it will be understood that the foregoing is considered as illustrative only of the principles of the invention and not intended to be exhaustive or to limit the invention to the precise forms disclosed. Obvious modifications or variations are possible in light of the above teachings. The embodiments discussed were chosen and described to provide the best illustration of the principles of the invention and its practical application to enable one of ordinary skill in the art to utilize the invention in various embodiments and with various modifications as are suited to the particular use contemplated All such modifications and variations are within the scope of the invention as determined by the appended claims when interpreted in accordance with the breadth to which they are entitled.

What is claimed is:

1. An electronic medical second opinion system for medical professional members, comprising:
a membership registration module that activates membership based on member's verified medical license;
a second opinion module that includes a request for second medical opinion component, a second opinion submission component and a final medical second opinion producing component, wherein a request for medical second opinion is posted to all members and a member's second opinion is submitted and analyzed into a final medical second opinion; and
a sever that electronically connects, correlates and controls the functions of said membership registration module and said second opinion module.

2. The electronic medical second opinion system of claim 1, wherein said membership registration module generates a username with indication of a member's area of expertise.

3. The electronic medical second opinion system of claim 1, wherein a request for medical second opinion is generated using a standard form wherein each symptom is presented in a hierarchy order.

4. The electronic medical second opinion system of claim 1, wherein a member's second opinion is generated using a standard form wherein each solution step is presented in a hierarchy order, assigned with different points.

5. The electronic medical second opinion system of claim 4, wherein said final medical opinion is formed by grouping similar solution steps of plurality of participating members together, and summing the collective points and ranking the solution steps from high summed points to low summed points.

6. The electronic medical second opinion system of claim 4, wherein said final medical opinion is formed by statistically summarizing submitted second opinions, and giving more weight to members having more experiences.

7. The electronic medical second opinion system of claim 1, further comprising a monitoring module that tracks the performance of each member.

8. The electronic medical second opinion system of claim 1, further comprising a module that provides blogging and news services for registered members.

9. A method for generating medical second opinions, comprising the actions of:
electronically connecting a network of medical professionals having variety of medical experiences;
posting a request for medical second opinion on the network;
receiving plurality of suggestions from network members;
statistically analyzing and summarizing the plurality of suggestions; and
forming a final second opinion based on the statistical analysis.

10. The method of claim 9, wherein said action of statistical analyzing comprises providing a higher weight ratio for members having more experience.
